(19) United States
(12) Patent Application Publication
(10) Pub. No.: US 2017/0334780 A1
(43) Pub. Date: Nov. 23, 2017

(54) PHOTOLUMINESCENT CEMENTITIOUS COMPOSITIONS BASED ON HYDRAULIC BINDERS PARTICULARLY SUITABLE FOR USE IN SAFETY SIGNS

(71) Applicant: ITALCEMENTI S.P.A., Bergamo (IT)

(72) Inventors: Roberta ALFANI, Aix en Provence (FR); Gianluca LEZZI, Bergamo (IT)

(21) Appl. No.: 15/521,043

(22) PCT Filed: Oct. 23, 2015
(86) PCT No.: PCT/EP2015/074633

§ 371 Date: Apr. 21, 2017

(30) Foreign Application Priority Data
Oct. 23, 2014 (IT) MI2014A001829

(51) Int. Cl. C04B 28/04; C04B 111/60; C04B 103/00; C04B 111/00; C04B 111/80; C04B 111/72

(52) U.S. Cl. CPC C04B 28/04; C04B 2111/807; C04B 2111/72; C04B 2103/001; C04B 2111/00586; C04B 2111/60

(57) ABSTRACT

The present invention relates to a photoluminescent cementitious composition suitable for use in safety signs in accordance with DIN 67510-1 standard, characterized by including a hydraulic binder, an aggregate and/or a filler and at least a photoluminescent pigment selected from strontium aluminates or silicates doped with rare earths selected from europium and dysprosium. The invention also relates to the use of a photoluminescent pigment in the manufacturing of concrete articles with aesthetic quality given by persistent photoluminescent properties.

### FIELD OF THE INVENTION

The present invention relates to a photoluminescent cementitious composition based on a hydraulic binder, in particular a cementitious composition particularly suitable for use for safety signs or also for manufacturing articles with aesthetic quality.

### BACKGROUND OF THE INVENTION

Luminescence is the physical phenomenon that proceeds through the absorption of energy by a body and the subsequent light emission. These phenomena are classified according to the source of energy that causes luminescence. Photoluminescence is a process in which a substance absorbs photons producing the effect of an initial excited state at a higher energy state followed by the return to the previous state and consequent re-emission of photons. With the interruption of the light source and a further photons absorption, photoluminescence ends within a given time, called decay time, or sometimes afterglow.

Photoluminescent materials are characterized by measuring the luminance thereof as a function of time. By luminance it is meant the luminous intensity emitted by the material towards a surface normal to the direction of the luminous flow emitted by the area of the surface itself. Its unit of measurement is called candela/square meter, cd/m², or millicandela/square meter, mcd/m².

Photoluminescent substances capable of absorbing energy from light sources, either natural or artificial, to then re-emit it in the form of photons are called phosphors. Photoluminescent pigments are particularly known among the phosphors which have a prolonged afterglow, thus potentially useful for a use for night safety signs.

In this respect, a photoluminescent substance can be used in the field of safety signs only if it meets the requirements described in specific regulatory standards in connection with the decay time, defined by a logarithmic extrapolation of the measured luminance values.

According to the objects of the present invention, particular reference is made to DIN 67510-1 on safety signs. According to this standard, luminance is measured at 2, 10, 30 and 60 minutes in the dark, following a light irradiation of 1000 lux for 10 minutes with a xenon light source.

The DIN 67510-1 standard provides as decay time that within which luminance falls below 0.3 mcd/m². The decay time at luminance 0.3 mcd/m² must be greater than 340 minutes.

Again as part of the requirements of the DIN 67510-1 standard, 10 minutes after the end of the irradiation with xenon lamp, the luminance value must be at least 20 mcd/m², and after 60 minutes not less than 2.8 mcd/m².

In the specific field of cementitious materials, cases are known where phosphors pigments with photoluminescent effect are used, typically made of doped zinc sulfide, however they are not able to meet the law requirements that allow their use in the field of safety signs, especially due to a too short decay time. Therefore, they are cementitious articles, such as blocks and coatings, provided with photoluminescence properties for decorative and ornamental purpose only.

The object of the invention is to provide cementitious compositions, or in any case based on a hydraulic binder, with photoluminescence properties suitable for use in safety signs in accordance with DIN 67510-1 standard.

In particular, to this end, it is desired that such compositions are suitable for forming a coating layer in the form of paint, render or plaster of various substrates, such as traffic separation elements, road or pavement plates and surfaces in general, wall structures, fronts and roofs of buildings, architectural and/or urban design elements. Therefore, also the aspect related to the rheological behavior of the subject cementitious compositions becomes critical, which should allow the application of the composition to the desired substrate in fluid state in the form or paint, or render or plaster with no problems of coating or adhesion. In fact, it must be considered that the rheology of such forms is quite varied, since a paint is highly fluid and tends to leach out, while a plaster has higher viscosity, tends to leveling and not to leaching, a render having intermediate features between the two cases.

### SUMMARY OF THE INVENTION

In order to achieve such objects together, the present invention provides a photoluminescent cementitious composition suitable in particular for use in safety signs in accordance with DIN 67510-1 standard, characterized by including a hydraulic binder, an aggregate and at least a photoluminescent pigment selected from strontium aluminates and silicates doped with rare earths selected from europium (Eu) and/or dysprosium (Dy).

Depending on the doping substance, said pigment therefore has formula SrAl₂O₄:Eu⁺², Dy⁺², B⁺³; or Sr₂SiO₄:Eu⁺², Dy⁺², B+³.

### DESCRIPTION OF THE INVENTION

In an embodiment of the invention, a photoluminescent pigment according to the present invention includes doped strontium aluminates or silicates.

In a different embodiment, a photoluminescent pigment according to the present invention includes doped strontium aluminates and silicates together.

In both the above embodiments, a photoluminescent pigment according to the present invention may include the doping substances europium and dysprosium, either separately or together.

To this end, by way of a non-limiting example, a photoluminescent pigment based on strontium aluminate according to the present invention contains the following oxides: SrO, Al₂O₃, Dy₂O₃, Eu₂O₃.

Yet by way of a non-limiting example, the following table 1 shows a semi-quantitative analysis using x-ray fluorescence (XRF) spectrometry referred to a photoluminescent pigment according to the present invention containing oxides SrO, Al₂O₃, Dy₂O₃, Eu₂O₃.

TABLE 1

| Oxides | % |
|---|---|
| SrO | 60.74 |
| Al₂O₃ | 32.03 |
| Dy₂O₃ | 2.05 |
| Eu₂O₃ | 1.41 |
| Other | 3.77 |

### DETAILED DESCRIPTION OF THE INVENTION

Photoluminescent pigments according to the invention are solid powders with particles having sizes preferably in the range of between 0.1 μm and 10 mm. It is practice to indicate the mean sizes thereof with reference to a parameter X₅₀ defined as follows: in the field of fine particle sizes, for example X₅₀(μm)=60 indicates that 50% of the particles have a diameter of less than 60 μm; while for coarser pigments, for example X₅₀(mm)=2 indicates that 50% of the particles have a diameter of less than 2 mm.

For the purposes of the present invention, the photoluminescent pigments used are preferably in the range X₅₀(μm)=10-500, more preferably between 20 and 300, even more preferably between 30 and 150.

In a preferred embodiment, the composition of the invention comprises:
a) a hydraulic binder;
b) at least a rheology modifying agent;
c) a calcareous, siliceous or silico-calcareous aggregate;
d) one or more of said photoluminescent pigments;

More in particular, with reference to said components a), b), c):

a) by hydraulic binder it is meant a hydraulic cementitious material in the form of dry powder which, once mixed with water, provides plastic mixtures able to strengthen and harden. The definition includes cements as defined by UNI EN 197-1 standard (white, grey or pigmented), cement agglomerates, hydraulic limes as defined by law IT 595 (May 26, 1965), and mixtures thereof.
In order to form a coating according to the present invention, it is possible to use calcium sulfoaluminous-based binders such as the compounds described in patents and/or patent applications W02006/18569, EP-A-1306356 and EP-A-0181739, as well as those derived from calcium sulfoaluminous clinkers described in the Review “Green Chemistry for sustainable cement production and Use” by John W. Phair Green Chem., 2006, 8, 763-780, in particular in chapter 5.3 on page 776, and also from the calcium sulfoaluminous clinkers described in the article “Calcium sulfoaluminates cements—low energy cements, special cements” J. H. Sharp et al., Advances in Cement Research, 1999, 11, n. 1, pages 3-13. Alternatively, aluminous, sulfo-ferroaluminous cements may also be appropriately used as described in Advances in Cement Research, 1999, 11, No. 1, January 15-21. According to the present invention, photocatalytic cements may also be used for making the articles, i.e. binders having photocatalytic activity obtained by adding a photocatalyst to the mixture able to oxidize, in the presence of light, air and humidity, the polluting organic and inorganic substances present in the environment. Examples of photocatalytic cement are the products of the range TX® (Italcementi), such as TX Active®.

In a preferred embodiment of the invention, cement Italbianco® 52.5 R of Italcementi, cement Rocca Bianca® 42.5R and cement Aquila Bianca® 32.5R of Italcementi are used as binders. The composition for making a coating according to the present invention can also optionally include anhydrite or chalk.

b) a rheology modifying agent includes a cellulosic ether or chemically modified starch having viscosity in the range from 200 to 120000 MPA·s, meaning Brookfield viscosity measured at 20° C. in 2% solution in the case of cellulosic ether, and in 5% solution in the case of chemically modified starch.

Suitable cellulosic ethers for example are methyl hydroxyethyl cellulose (examples of commercial products: Culminal®, Walocel®, Tylose®); ethylcellulose, hydroxypropyl cellulose, hydroxypropylethylcellulose, methylcellulose, carboxylmethylcellulose, methylcarboxypropylmethylcellulose.

Suitable chemically modified starches for example are the products available on the market called Aqualon (Ashland).

c) suitable calcareous, siliceous or silico-calcareous aggregates for use in cementitious compositions of the invention are defined according to UNI EN 13139 and UNI EN 12620 standards. Such aggregates are used to obtain greater resistance, lower porosity and reduced efflorescence. The aggregates may be suitably selected from calcareous, quartz or silico-calcareous aggregates in any form, such as crushed or spherical.

As an aggregate according to said component c), a composition of the invention may include one or more fine-grained fillers defined according to UNI EN 13139 standard, of mineral origin, such as calcareous, siliceous or silico-calcareous fillers or quartz.

Further components of the composition of the invention are selected from: organic and/or inorganic pigments; materials with pozzolanic activity, such as preferably microsilica, fly ash, metakaolin, natural pozzolans; materials with latent hydraulic activity such as blast furnace slag; hydrated limes; natural limestone. A composition of the invention may optionally include further additives commonly used in cementitious compositions. By way of a non-limiting example, we may mention fluidizers, superfluidizers, air entraining agents, pigments, defoamers, waterproofing agents, non-shrinking agents, tackifying agents such as acrylic or vinyl polymers such as polyvinyl acetate, polyvinylversatate, polybutylacrylate. Examples of such tackifying products available on the market are the Elotex products such as Elotex FL1210®.

Said compositions can be obtained by mixing the respective components in any order. In particular, the photoluminescent pigment can be added to the different components of the mixture according to various options. Preferably, the components are mixed together in a dry state in a suitable mixer, such as a planetary mixer or a drill mixer for a time, such as 3 minutes, necessary to achieve good homogenization.

Water is then added to the dry mixture thus produced in the proportions required and mixing is continued for the time needed (e.g. 5 minutes) to obtain a smooth and homogeneous mortar, suitable to be applied as a photoluminescent coating layer in the form of paint, or render or plaster.

A mortar suitable for the final application is obtained by adding water, preferably according to a water/hydraulic binder weight ratio ranging from 0.2 to 3. The differentiation between the paint, render or plaster form is obtained in relation to both such a water content and to the grain size of the components present, in particular of the aggregate.

For the end use, the photoluminescent compositions of the invention can be applied on relative substrates or supports for sign use in layers of variable thickness; preferably, the coating layer thickness is in the range between 0.2 and 20 mm.

The cementitious articles for safety signs in accordance with DIN 67510-1 at least partly coated on the surface with said photoluminescent compositions are also an object of the invention. Non-limiting examples of such articles are a traffic separation element, a panel, a plate, a road surface, pavement, floor structure, wall structure, front and roof of a building, architectural or urban design element. Cementitious articles produced or surface-coated, at least partly, with said photoluminescent compositions for applications even in fields other than safety, such as articles with an ornamental or aesthetic value are also an object of the invention.

Object of the present invention are also cementitious compositions suitable to provide high-tech mortars for restoration and repair applications, and for producing non-structural elements such as architectural facades and manufactured articles having design of decorative nature.

### DESCRIPTION OF THE DRAWINGS

FIG. 1 in the accompanying drawing shows a spectrum obtained by scanning electron microscopy (SEM) performed on a photoluminescent pigment according to the invention. The ordinates show the count rate expressed in cps, counts per second; the abscissas the voltage expressed in keV.

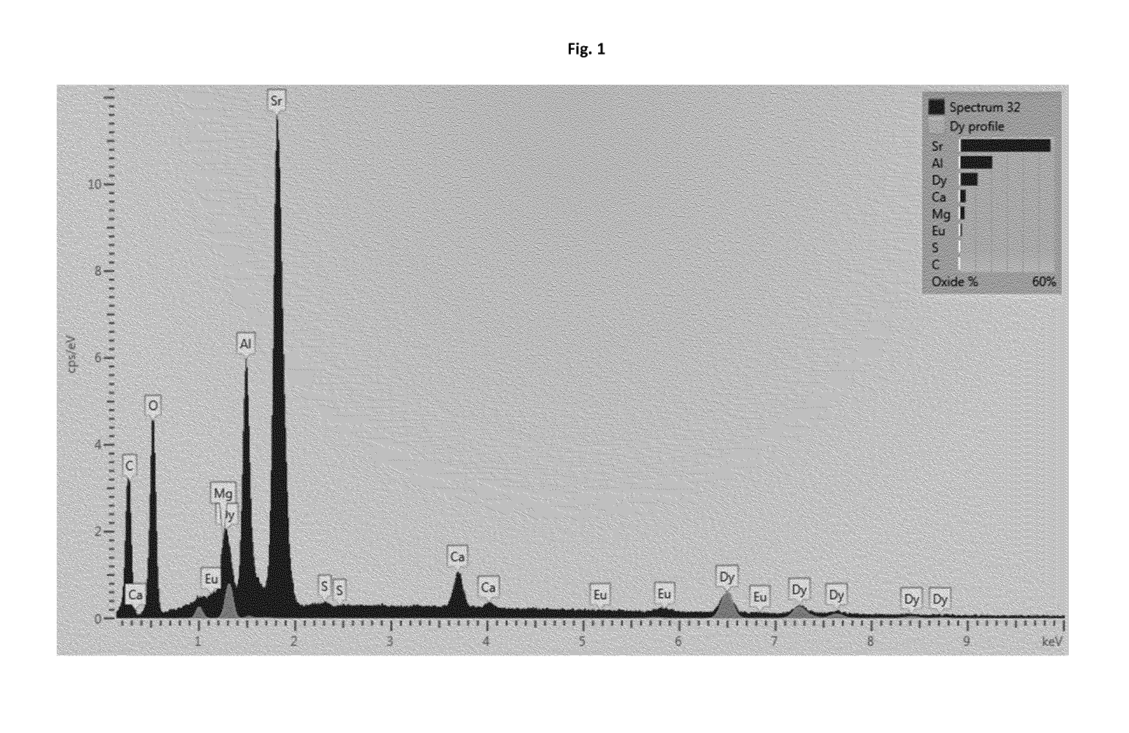

The profile of the components measured, including SrO, Al₂O₃, Dy₂O₃, Eu₂O₃, is summarized at the top of the spectrum.

### EXAMPLES

In order to better understand the features and the advantages of the invention, non-limiting embodiment examples are described hereinafter.

### Example 1

The following cementitious composition suitable as a render, was prepared according to the invention:

| Component | % by weight |
|---|---|
| Rocca Bianca 42.5 R cement | 14.57 |
| Calcareous aggregates, component c) | 78.96 |
| Fiore hydrated lime | 1.63 |
| FL1210 (Elotex) | 1 |
| vinyl or acrylic polymer, tackifying agent | |
| Aqualon ST 2000 (Ashland) | 0.1 |
| chemically modified starch, 300-800 | |
| MPA.s, rheology modifier | |
| MHG-6B (Arcacolour) | 3.74 |
| photoluminescent pigment | |
| strontium aluminate (Sr₂AlO₄:Eu⁺², Dy⁺²) | |
| Water, % by weight on the pre-mix | 20 |

All the components in the form of powder were mixed in an intensive Eirich type mixer for 5 minutes in order to achieve good homogenization; water was then added and mixing was continued for another 3 minutes. The resulting cementitious mortar was applied as a coating layer in the form of finishing render, using a spatula, on a plasterboard panel sized 50×50 cm. The applied render thickness is equal to 2 mm.

Luminance measurements, expressed in mcd/m² at the times (minutes) in accordance with DIN 67150, were carried out on the coated panel as described above after 7 days from preparation, and reported along with the decay time in the following table:

| Luminance values | | | |
|---|---|---|---|
| minutes | 10 ± 0.1 | 60 ± 0.3 | 1150 |
| mcd/m² | 20.1 | 4.2 | 0.3 |

### Example 2

The following cementitious composition suitable as a paint, was prepared according to the invention:

| Component | % by weight |
|---|---|
| Rocca Bianca 42.5 R cement | 27.79 |
| Calcareous filler, component c) | 59.13 |
| Fiore hydrated lime (Unicalce) | 1.46 |
| FL1210 (Elotex) | 1 |
| vinyl or acrylic polymer | |
| tackifying agent | |
| C4051 (Culminal) | 0.21 |
| Methylcellulose, 65000-85000 mPa.s, | |
| rheology modifier | |
| AGITAN P845 (Munzing) | 0.1 |
| polyglycol, air removing agent | |
| MHG-2C (Arcacolour) | 10.31 |
| photoluminescent pigment | |
| strontium aluminate | |
| (Sr₂AlO₄:Eu⁺², Dy⁺²) | |
| Water, % by weight on the pre-mix | 65 |

All the components in the powder phase were mixed in an intensive Eirich type mixer for 5 minutes in order to achieve good homogenization; water was then added and mixing was continued for other 3 minutes. The resulting cementitious mortar was applied as a coating layer in the form of paint using a brush on a concrete slab sized 40×40 cm. Luminance measurements, expressed in mcd/m² at the times (minutes) in accordance with DIN 67150, were carried out on the coated panel as described above after 7 days from preparation, and reported along with the decay time in the following table:

Luminance values

| | | | |
|---|---|---|---|
| minutes | 10 ± 0.1 | 60 ± 0.3 | 630 |
| mcd/m² | 20.3 | 3.7 | 0.3 |

### Comparative Example 3

By following a similar process, the following reference cementitious composition was prepared, corresponding to the composition of example 2 except for a different photoluminescent pigment not belonging to the invention, i.e. zinc sulfide doped with copper, ZnS:Cu.

| Component | % by weight |
|---|---|
| Rocca Bianca 42.5 R cement | 27.79 |
| Calcareous filler | 59.13 |
| Fiore hydrated lime | 1.46 |
| FL1210 (Elotex) | 1 |
| C4051 (Culminal) | 0.21 |
| Methylcellulose, 65000-85000 mPa.s, | |
| rheology modifier | |
| AGITAN P845 (Munzing) | 0.1 |
| Lumilux N-FG (Honeywell) | 10.31 |
| photoluminescent pigment | |
| zinc sulfide doped with copper, ZnS:Cu | |
| Water, % by weight on the pre-mix | 65 |

All the components in the powder phase were mixed in an intensive Eirich type mixer for 5 minutes in order to achieve good homogenization; water was then added and mixing was continued for another 3 minutes. The resulting cementitious mortar was applied as a coating layer in the form of paint using a roller on a concrete slab sized 40×40 cm, having the function of a luminous sign. Luminance measurements, expressed in mcd/m² at the times (minutes) in accordance with DIN 67150, were carried out on the slab painted as described above after 7 days from preparation, and reported along with the decay time in the following table:

Luminance values

| | | |
|---|---|---|
| minutes | 10 ± 0.1 | 60 ± 0.3 |
| mcd/m² | 1 | 0 |

The following conclusions are drawn from the above examples.

Bearing in mind that in order to meet DIN 67510-1 standard, after 10 minutes the luminance value must be at least 20 mcd/m², after 60 minutes not less than 2.8 mcd/m² and the decay time at luminance 0.3 mcd/m² must be greater than 340 minutes, it is seen that the compositions of examples 1 and 2 according to the invention meet these requirements while this is not the case for example 3, which at 10 minutes already shows a luminance close to decay, which is reached at the measurement after 60 minutes. On the other hand, it is seen that in particular the composition of example 1 according to the invention allows reaching a decay time of more than 19 hours.

Furthermore, the compositions of the invention were found to be provided with optimum rheology within the usage scope object of the invention.

The invention therefore achieves the object of providing a photoluminescent cementitious composition according to the reference standard, and together provided with optimum rheology, easily applicable at the fluid state on the desired substrate according to the need in the form of paint or render or plaster, using a limited number of components.

Compliance with DIN 67510-1 standard allows applications for photoluminescent safety signs alternative to non-cement signs, often more expensive.

As an alternative use, a photoluminescent cementitious composition according to the present invention also allows the manufacturing of articles with aesthetic or ornamental quality given by the persistent photoluminescent properties thus obtained.

1. Photoluminescent cementitious composition suitable for use in safety signs in accordance with DIN 67510-1 standard, characterized by including a hydraulic binder, an aggregate and at least a photoluminescent pigment selected from strontium aluminates and silicates doped with rare earths selected from europium and/or dysprosium.

2. Composition as claimed in claim 1 characterized in that said pigment has formula SrAl₂O₄:Eu⁺², Dy⁺²; or Sr₂SiO₄:Eu⁺², Dy⁺².

3. Composition as claimed in claim 1 characterized in that said photoluminescent pigment is a doped strontium aluminate.

4. Composition as claimed in claim 1 characterized in that said photoluminescent pigment is a doped strontium silicate.

5. Composition as claimed in claim 1 characterized in that said photoluminescent pigment comprises doped strontium aluminates and silicates together.

6. Composition as claimed in claim 1 characterized in that said photoluminescent pigment includes europium or dysprosium together as doping substance.

7. Composition as claimed in claim 1 characterized in that said photoluminescent pigment includes europium and dysprosium together as doping substance.

8. Composition as claimed in claim 1 characterized in that said photoluminescent pigment comprises the following oxides: SrO, Al₂O₃, Dy₂O₃, Eu₂O₃.

9. Composition as claimed in claim 1 characterized in that said pigment is in the form of a solid with particle size ranging between 0.1 μm and 10 mm

10. Composition as claimed in claim 9 characterized in that said pigment has particle size in the range X₅₀(μm)=10-500.

11. Composition as claimed in claim 10 characterized in that said pigment has particle size in the range X₅₀(μm)=20-300.

12. Composition as claimed in claim 10 characterized in that said pigment has particle size in the range X₅₀(μm)=30-150.

13. Composition as claimed in claim 1 characterized in that it comprises:
a) a hydraulic binder;
b) at least a rheology modifying agent;
c) a calcareous, siliceous or silico-calcareous aggregate;
d) one or more of said photoluminescent pigments.

14. Composition as claimed in claim 13 characterized in that said hydraulic binder is a cement.

15. Composition as claimed in claim 13 characterized in that said rheology modifying agent is a cellulosic ether or a chemically modified starch, having Brookfield viscosity ranging between 200 and 120000 mPa·s.

16. Composition as claimed in claim 13 characterized in that said c) aggregate consists, at least in part, of one or more fillers in accordance with UNI EN 13139 standard.

17. Method for providing safety signs in accordance with DIN 67510-1 standard, characterized in that a photoluminescent pigment is selected from strontium aluminates and silicates doped with rare earths selected from europium and/or dysprosium, and it is formulated in a composition comprising a hydraulic binder and an aggregate, and/or a filler.

18. Method as claimed in claim 17 characterized in that said pigment is formulated in a composition as claimed in claims from 1.

19. Method as claimed in claim 17 characterized in that said composition is mixed with water in order to obtain a fluid and homogeneous mortar, suitable to be applied as a photoluminescent coating layer in the form of paint, or render or plaster on a suitable substrate for safety signs in accordance with DIN 67510-1 standard.

20. Method as claimed in claim 17 characterized in that said composition is mixed with water according to a water/hydraulic binder weight ratio ranging from 0.2 to 3.

21. Method as claimed in claim 19 characterized in that the thickness of said coating layer is in the range between 0.2 e 20 mm.

22. Manufactured article for safety signs in accordance with DIN 67510-1 standard characterized in that it includes a suitable substrate, such as a traffic separation element, a panel, a plate, a road surface, pavement, floor structure, wall structure, front and roof of a building, architectural or urban design element, said substrate being coated at least in part by a paint, or render or plaster layer consisting of a composition as claimed in claim 1.

23. Method for manufacturing articles having aesthetic quality given by persistent photoluminescent properties, characterized in that a photoluminescent pigment is selected from strontium aluminates and silicates doped with rare earths selected from europium and/or dysprosium, and it is formulated in a composition including a hydraulic binder and an aggregate, and/or a filler.

24. Method for manufacturing high-tech mortars for restoration and repair applications, and for producing non-structural elements such as architectural facades and manufactured articles having design of a decorative nature, characterized in that a photoluminescent pigment is selected from strontium aluminates and silicates doped with rare earths selected from europium and/or dysprosium, and it is formulated in a composition comprising a hydraulic binder and an aggregate, and/or a filler.
